(19) United States
(12) Patent Application Publication
(10) Pub. No.: US 2012/0074167 A1
(43) Pub. Date: Mar. 29, 2012

(54) ADHESIVE PACKAGE

(75) Inventors: James Galvin, Cleveland, OH (US); David L. Kunkle, Chelsea, MI (US); James D. Haaser, Lancaster, OH (US)

(73) Assignee: ADCO Products, Inc., Michigan Center, MI (US)

(21) Appl. No.: 13/246,498

(22) Filed: Sep. 27, 2011

Related U.S. Application Data
(60) Provisional application No. 61/386,939, filed on Sep. 27, 2010.

(51) Int. Cl. B67D 1/00; B65D 35/28

(52) U.S. Cl. 222/82; 222/95

(57) ABSTRACT

A package for holding a part of a two-part adhesive that is applied to a substrate includes a collapsible bag, an end cap attached at a first end of the bag, and a spout attached to a second end of the bag. As pressure is applied to the end cap, the part of the two-part adhesive is forced out of the spout.

### RELATED APPLICATION

This application claims the benefit of U.S. Provisional Application No. 61/386,939, filed Sep. 27, 2010. The content of the above application is incorporated herein by reference in its entirety.

### TECHNICAL FIELD

The present invention relates to packages for holding adhesives. More specifically, the present invention relates to collapsible packages for holding adhesives.

### BACKGROUND

The statements in this section merely provide background information related to the present disclosure and may or may not constitute prior art.

In many roofing applications, for example in large, flat commercial roof decks, a roofing membrane is used to seal and protect the roof deck from environmental weather conditions. The roofing membrane may be made of various materials, such as polymeric materials including EPDM (ethylene propylene diene M-rubber) or TPO (thermoplastic polyolefin). The roofing membrane is adhered overtop insulation boards or panels. The insulation boards are typically secured to the roofing substrate or roof deck via an adhesive composition. A conventional adhesive composition used to adhere the insulation boards to the roof deck includes polyurethane. The polyurethane adhesives are oftentimes applied directly onto the roof deck via an applicator system and the insulation boards are then laid onto the roof deck surface. Conventional polyurethane adhesives oftentimes include two separate parts that are mixed by an applicator just prior to being applied onto the surface of the roof deck. The two parts include an isocyanate blend and a simple polyol blend. Upon mixing, the isocyanate blend reacts or crosslinks with the simple polyol blend to form the polyurethane adhesive.

However, these conventional two-part polyurethane adhesives are sensitive to weather conditions due to the effects of temperature on the viscosity, and therefore the reaction speed, of the adhesive. Accordingly, conventional two-part polyurethane adhesives are packaged and formulated into various grades, such as Summer, Winter, and Regular, that vary the composition of the adhesive in order to account for temperature.

Therefore, there is room in the art for adhesive packages for a pump driven applicator system that reliably pumps adhesives of different viscosities.

### SUMMARY

A package for holding a part of a two-part adhesive that is applied to a substrate includes a collapsible bag, an end cap attached at a first end of the bag, and a spout attached to a second end of the bag. As pressure is applied to the end cap, the part of the two-part adhesive is forced out of the spout.

The various embodiments described above may include one or more of the following benefits and advantages. The bag is crushable and is integrated with the without leaking. The package is moisture proof for at least one year, is DOT qualified, has low elongation, and has no shape memory. Further, some arrangements of the package can stand on a roof and can receive custom art work.

Further features, advantages, and areas of applicability will become apparent from the description provided herein. It should be understood that the description and specific examples are intended for purposes of illustration only and are not intended to limit the scope of the present disclosure.

### DRAWING DESCRIPTION

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1A is a schematic diagram of a device for applying a two-part adhesive in accordance with the principles of the invention;

FIG. 1B is a schematic diagram of an alternative embodiment of the device in accordance with the principles of the invention;

FIG. 2 is a schematic diagram of a particular arrangement for the pumps and adhesive package for the device;

FIG. 3 is a close up view of an adhesive package positioned in a portion of a pump;

FIG. 4 is a side view of a package for holding an adhesive in accordance with the principles of the invention;

FIG. 5 is a close up side view of an alternative embodiment of package bag in accordance with the principles of the invention.

### DETAILED DESCRIPTION

The following description is merely exemplary in nature and is not intended to limit the present disclosure, application, or uses.

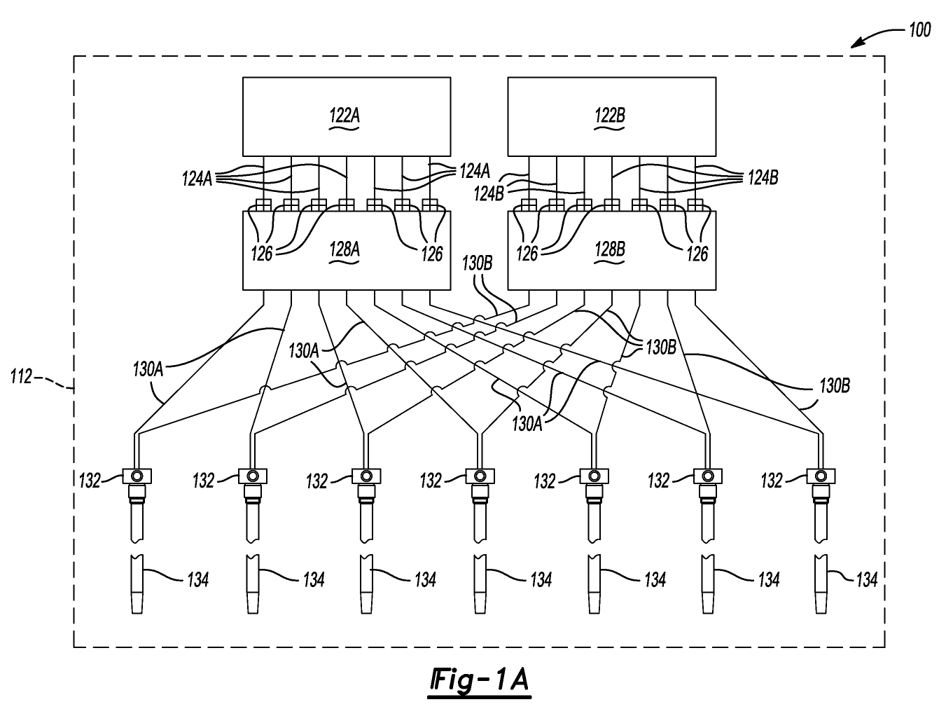

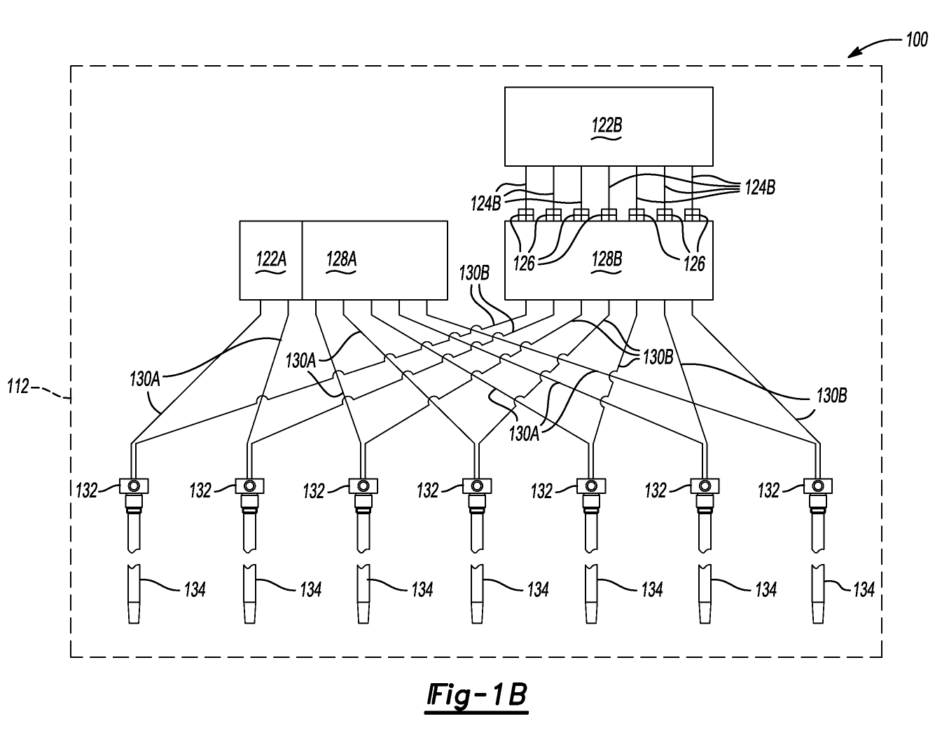

Referring to FIG. 1A, a device for applying a two-part fluid to a substrate is generally indicated by reference number 100. The device 100 may include a carrier or frame like the frame 112 described in the previous embodiments. The carrier or frame 112 is used to support the various components of the device 100 and may take many forms without departing from the scope of the present invention. In the example provided, the carrier 112 includes a rectangular base with an upwardly extending portions or support columns. The rectangular portion includes two rotatable front wheels and two spindle mounted back wheels. Back wheels are pivotable and rotatable allowing the device 100 to move forward as well as turn and rotate. The portion supports an upper frame that is sized to receive two parts of a two-part compound. These two parts are packaged separately and include an “A” side package 122A and a “B” side package 122B. Each of the packages preferably contain one part of a two part all weather polyurethane adhesive for use on roofing substrates. The upper frame is designed to accommodate a particular package configuration of the A side 122A and the B side 122B. Each of the packages 122A and 122B may be a bag with one or more hoses 124A and 124B, respectively, extending from each bag. In the example shown in FIG. 1A, seven hoses 124A extend from bag 122A and seven hoses 124B extend from bag 122B, and a shut-off valve 126 is associated with each hose to enable the operator of the device 100 to selectively open or close each of the hoses 124A, 124B.

Each of the hoses 124A, 124B connects to respective pumps 128A, 128B. Specifically, the seven hoses 124A extending from package 122A connect to pump 128A, and the seven hoses 124B extending from package 122B connect to pump 128B. In another arrangement, all of the hoses 124A and 124B from the packages 122A and 122B connect to a single pump. In a particular arrangement, each of the hoses 124A and 124B connects to a single pump.

As shown in FIG. 1A, a set of seven outlet hoses 130A extends from the pump 128A and another set of outlet hoses 130B extends from the pump 128B. Each of the outlet hoses 130A is paired with a respective outlet hose 130B, and each of the paired outlet hoses 130A and 130B connects to respective inlet ports 131A and 131B of a manifold 132. Accordingly, there are seven manifolds, each associated with a pair of outlet hoses 130A and 130B, and associated with each manifold 132 is a mixer nozzle 134. The manifolds 132 may be made from aluminum or from a disposable plastic. Each of the manifolds 132 may include two inlet ports that communicate with separate channels or bores which in turn communicate with respective outlet ports.

The nozzle 134 is an extended member that mixes the “A” side fluid with the “B” side fluid. The nozzle 134 is coupled to manifold 132 and communicates with the outlet ports of the manifold 132. The nozzle 134 is disposable and is preferably a 36 element mixing nozzle, though it should be appreciated that other types and grades of nozzles may be employed without departing from the scope of the present invention. Once the fluids from the “A” and “B” sides are mixed, the combined fluid exits in the nozzle 134 and is dispensed in the form of elongated beads on the roofing substrate. A restriction orifice may be disposed between the manifold 132 and the nozzle 134. The orifice may be integrated into the nozzle. The nozzle 134 may be threaded into the manifold 132 or it may be a quick release nozzle for faster change-outs. The mixer nozzle 134 may be configured to be quickly releasable from the manifold 132 by eliminating the threads and attaching the nozzle to the manifold 132 with or similar device.

When the device 100 is in use, an operator activates the device 100 to drive the pumps 128A and 128B. The pumps 128A and 128B suck fluid from the “A” and “B” side packages 122A and 122B through the hoses 124A and 124B, respectively, that have not been closed with shut-off valves 126. In turn, the pumps 128A and 128B pump the “A” and “B” fluids through the outlet hoses 130A and 130B to the manifolds 132. Accordingly, each manifold 132 receives “A” and “B” and directs the fluids to respective nozzles 134 for mixing. The pumping action of the pumps 128A and 128B ejects the mixture through the outlet of the nozzle 134 as a foam adhesive that is applied to a substrate such as a roof. By widening or narrowing the distance between adjacent nozzles 134, the operator can adjust the width of the area covered with the device 100.

In some arrangements, the adhesive package may be combined or integrated into a portion of the pump. For example, as shown in FIG. 1B, the “A” component 122A is inserted or contained directly in the pump 128A, thus eliminating the hoses 124A. Although FIG. 1B shows the “B” component 122B connected to the pump 128B with hoses 124B, the “B” component could be contained in the pump 128B as well.

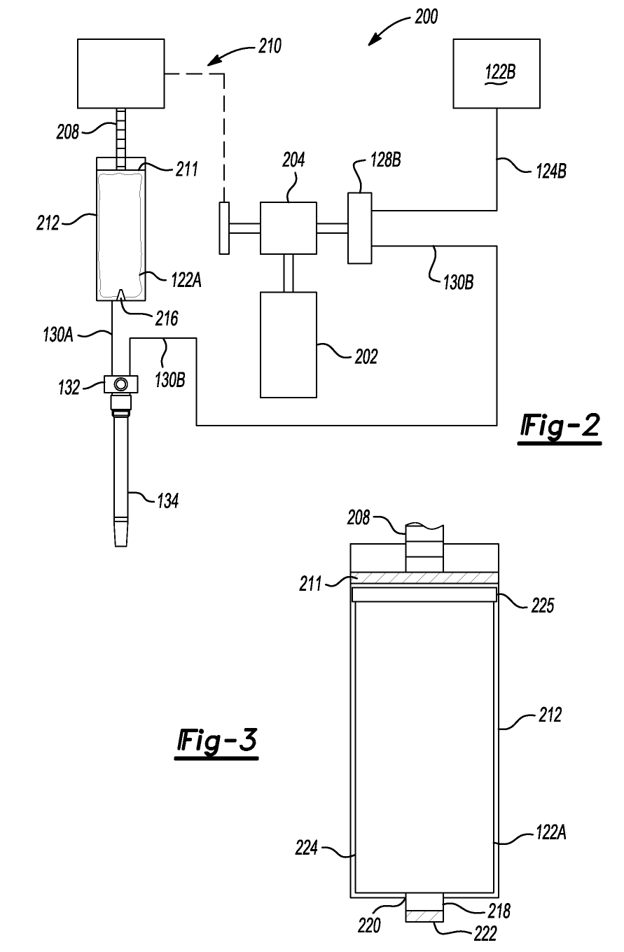

Turning now to FIG. 2, there is shown a particular arrangement of the device shown in FIG. 1B and is generally indicated by the reference number 200. Note that like components are indicated by like reference numbers shown in the previous figures. The primary components of the device 200 include a motor 202 connected to a gear box 204. In turn, the gear box 204 is connected to the pump 128B that suck “B” fluid from “B” package 122B via hoses 124B and pumps “B” fluid through the hoses 130B to the manifolds 132. Other adhesive applicators that can be employed to pump components of the adhesive from the packages 122A or 122B described above as well as those below include the applicator described in U.S. Pat. No. 7,056,556, the content of which is incorporated herein by reference in its entirety.

The gear box is also connected to a jack and ball screw mechanism 208 via a mechanism 210. The mechanism 210 can be, for example, a ring and pinion mechanism or a chain and sprocket mechanism. A disk member 211 is attached to one end of the jack and ball screw mechanism 208. Also associated with each jack and ball screw mechanism 208 is a cylinder or tube 212.

Typically, the operator of the device 200 drops a sausage package 122A of “A” fluid into the tube 212. A sharp projection 216, for example, at the bottom of the tube 212, pierces the package 122A. Accordingly, as an operator, such as a roofer, operates the device 200, the motor 202 turns the gears in the gear box 204 that in turn causes the jack and ball screw mechanism 208 via the mechanism 210 to push the disk 211 against the package 122A. This causes the “A” fluid to be pushed out of the package 122A. The “A” fluid flows through respective hoses 130A to each manifold 132, and, as described previously, the “A” and “B” fluids are mixed together in the nozzle 134, and the mixture is ejected as an adhesive foam onto a substrate such as a roof. FIG. 2 shows device 200 arranged with one nozzle merely for illustrative purposes. Depending upon the application, there may as many as seven or more nozzles 134 associated with the device 200.

Referring now to FIG. 3, there is shown an inside view of a particular arrangement with the cylindrical tube 212 holding the package 122A (or the package 122B in other arrangements). The package 122A includes a spout 218 that extends through a hole 220 at the bottom of the container 212. The package 122A is shown with a storage cap 222 that is removed before the spout 218 and hence the 122A is connected to the hose 130A. The storage cap 222 can be screwed or snapped onto the spout 218, or can be attached by any other suitable means. The package 122A further includes an end cap 225 that slides down the cylinder 212 as the disk 211 pushes against the end cap 225. As the end cap 225 slides along the interior surface of the cylinder 212, it maintains its axial orientation with respect to the disk 211. The package 122A generally includes a flexible and collapsible bag 224 made from, for example, biaxially-oriented polyethylene terephthalate, which is a polyester film made from stretched polyethylene terephthalate and is generally available under the trade name Mylar®. Mylar® has a high tensile strength, chemical and dimensional stability, and gas barrier properties that are desirable for use as containers for adhesives. The spout 218 and the end cap 225 are made from any suitable plastic, and the bag 224 is heat sealed to the spout 218 and the end cap 225 or is attached to the spout and end cap by any other suitable process. Although as shown in FIG. 3, the bag 224 has a cylindrical shape, other shapes are contemplated as well, including but not limited to cubic or rectangular shapes.

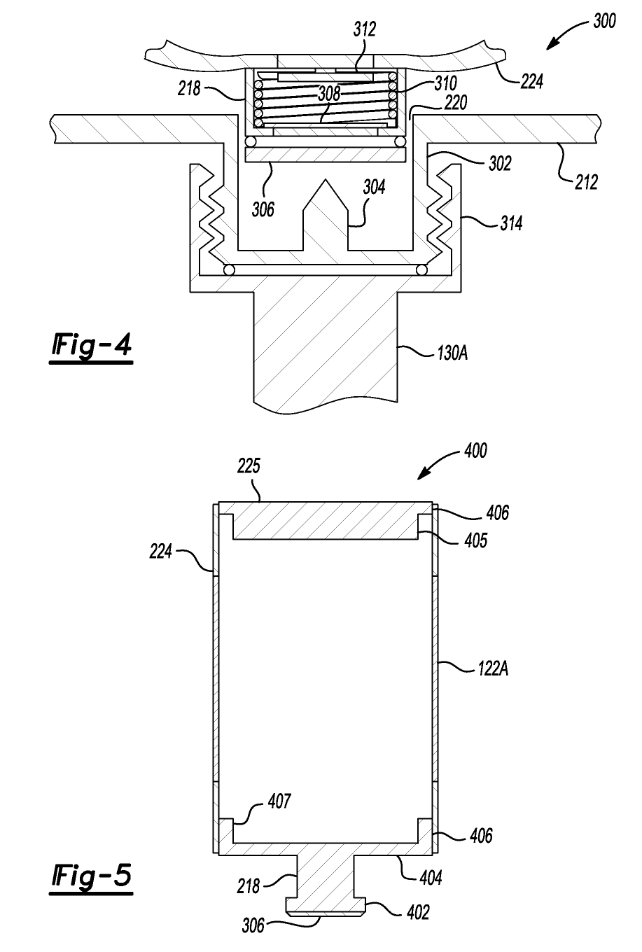

Turning to FIG. 4, there is shown a particular arrangement 300 for connecting the bag 224 to the hose 130A. The spout 218 is provided with a rupture disk or seal 306, a closure member 308 loaded by a spring 310, that is, the spring 310 applies a bias force to the closure member 308 away from the bag 224, and an anti-syphon valve 312. The container 212 includes an extension 302 that extends away from the container 212 with a piercing device 304 that projects towards the rupture disk or seal 306. Finally, the hose 130A (or in other arrangements the hose 130B) includes a quick connect coupler 314 that is configured to couple to the extension 302. Such quick connect couplers include those available from Colder Products of St. Paul, Minn.

Referring also to FIG. 2, to use the arrangement 300, the coupler 314 is initially connected to the extension 302. Again the coupler 314 can be a quick release mechanism for faster change-outs. For example, the coupler 314 and the extension 302 may be configured without threads and coupled together with a latch or any other suitable quick-release mechanism. The cap 222 is removed from the spout 218 and then the spout 218 is inserted into the opening 220 of the cylinder or container 212. As the spout 218 slides down the interior of the extension 302, the piercing device 304 pierces the seal 306. Initially, the closure member 308 prevents fluid from flowing from the package 122A (or 122B). As the spout 218 slides further into the interior of the extension 302, the closure member 308 contacts the piercing device 304 such that the spring 310 is then compressed until the closure member 308 pushes towards the valve 312, at which time fluid from the bag 224 is able to flow from the bag 224 into the hose 130A (or 130B) as pressure is applied to the top of the bag 224, for example, when the disk 211 is pressed against the end cap 225, as described earlier. When pressure is removed from the bag 224, the bias force of the spring 310 urges the closure member 308 away from the siphon valve 312, to close off the flow of fluid from the bag 223. Further, back flow from the hose 130A (or 130B) towards the bag 224 closes the siphon valve 312, preventing any back flow of fluid from the hose 130A (or 1308) back into the bag 224.

Referring now to FIG. 5, there is shown yet another arrangement 400 for the adhesive package 122A (or 122B). Here, the package includes a first end cap 404 with the spout 218 being an integrated extension of the first end cap. The spout 218 is provided with the rupture disk or seal 306, as described previously. The spout 218 also includes a locating feature 402 to help locate the package 122A (or 122B) in the container 212 and further limit movement of the package 122A (or 1228) in the container 212. Specifically, the diameter of the spout is sized relative to the hole 220 to minimize lateral movement of the package 122A (or 122B), and the diameter of the feature 402 is larger than the diameter of the hole 220 to prevent the spout 218 from being pushed back into the container 212 and to minimize axial movement of the spout 218. The second end cap 225 is provided with an interior portion 405 that is configure to mesh with the interior portion 407 of the end cap 404 to eliminate wastage of the fluid the end cap 225 is pressed down into the end cap 404. The end caps 225 and 404 are made of semi-rigid plastic that are attached around their inner periphery 406 to the Mylar® bag 224.

Referring also to FIG. 2, to use the package 122A (or 122B) shown in FIG. 5, the package 122A (or 122B) is inserted into the container 212. A piercing mechanism 216 pierces the rupture disk 306 to break the seal, which then allows fluid to flow from the bag 224 into the hose 130A (or 130B), as pressure is applied to the end cap 225 with the disk 211.

The description of the invention is merely exemplary in nature and variations that do not depart from the gist of the invention are intended to be within the scope of the invention. Such variations are not to be regarded as a departure from the spirit and scope of the invention.

What is claimed is:

1. A package for holding a part of a two-part adhesive that is applied to a substrate, the package comprising:
a collapsible bag;
an end cap attached at a first end of the bag; and
a spout attached to a second end of the bag, wherein as pressure is applied to the end cap, the part of the two-part adhesive is forced out of the spout.

2. The package of claim 1 wherein the end cap and the spout are attached to the bag by heat sealing.

3. The package of claim 1 wherein the bag is made from Mylar®.

4. The package of claim 1 further comprising a second end cap, the second end cap being attached to the second end of the bag, the spout being an integrated extension of the second end cap.

5. The package of claim 4 wherein the first and second end caps are generally planar.

6. The package of claim 5 wherein the first and second ends caps are configured to mesh together.

7. The package of claim 4 wherein the end caps are made from semi-rigid plastic.

8. The package of claim 1 wherein the spout is provided with a position feature to facilitate locating the package in a container and to minimize movement in the container.

9. The package of claim 1 wherein the spout includes a seal that is punctured by a piercing device.

10. The package of claim 1 further comprising an anti-syphon valve that prevents back flow of fluid into the bag.

11. The package of claim 10 further comprising a closure member and a spring with bias force that pushes the closure member away from the ant-syphon valve.

12. The package of claim 1 wherein the spout is configured with a quick-release mechanism.

13. The package of claim 1 wherein the bag has a generally cylindrical shape.

14. The package of claim 1 wherein the bag has a generally rectangular shape.

15. A container for receiving a package for holding a part of a two-part adhesive, the container comprising:
a semi-enclosed member with a first opening and a second opening smaller than the first opening, the package being inserted into the first opening such that a spout associated with the package extends through the second opening; and
an extended member that extends way from the semi-enclosed member, the extended member including a piercing device that is configured to puncture a seal attached to the spout of the package.

16. The container of claim 15 wherein the piercing device pushes against a closure member which in turn pushes against an anti-syphon valve to allow the part of the two-part adhesive to flow out of the package.

17. The container of claim 15 wherein the extended member includes a quick-release mechanism to couple the extended member to a hose.

18. The container of claim 15 wherein the container is associated with a pumping mechanism that applies a pressure at one end of the package to force the part of the two-part adhesive out of the spout.

19. The container of claim 15 wherein the container receives a generally cylindrically shaped package.

20. The container of claim 15 wherein the container receives a generally rectangular shaped package.
